(19) United States
(12) Patent Application Publication
(10) Pub. No.: US 2023/0082355 A1
(43) Pub. Date: Mar. 16, 2023

(54) SYSTEM AND METHOD FOR ASSOCIATING MOTION CONTROL SIGNALS FROM TRAFFIC LIGHT DEVICES WITH ROADWAY MOVEMENTS

(71) Applicant: GM Global Technology Operations LLC, Detroit, MI (US)

(72) Inventor: Joseph M. Burdge, West Bloomfield, MI (US)

(21) Appl. No.: 17/471,549

(22) Filed: Sep. 10, 2021

(51) Int. Cl. B60W 40/04; G06K 9/00; G08G 1/04; G08G 1/01; B60W 30/18; B60W 60/00

(52) U.S. Cl. CPC B60W 40/04; G06K 9/00798; G06K 9/00825; G08G 1/04; G08G 1/0112; B60W 30/18159; B60W 60/001; B60W 2420/42; B60W 2555/60; B60W 2552/53; B60W 2556/40

(57) ABSTRACT

A vehicle, system and a method of operating the vehicle is disclosed. The system includes a first sensor, a second sensor and a processor. The first sensor captures an image of a traffic control device. The second sensor identifies a lane within a road that is occupied by the vehicle. The processor is configured to determine an attribute of the lane occupied by the vehicle, associate a semantic meaning to a motion control signal of the traffic control device, determine a maneuver for the vehicle based on the semantic meaning of the motion control signal and the attribute of the lane occupied by the vehicle, and perform the maneuver at the vehicle.

### INTRODUCTION

The subject disclosure relates to maneuvering an autonomous vehicle through an intersection and, in particular, to a system and method for interpreting a meaning of a traffic signal from a traffic control device and moving the autonomous vehicle through the intersection based on the meaning.

When entering or approaching an intersection, it is necessary to be able to read a traffic light to pass through the intersection safely. For some intersections, the placement of a traffic light with respect to an approaching can be selected such that its instructions are clearly meant for a vehicle in the approaching lane. However, in other intersections, the placement of the traffic light is not selected in the manner, requiring the driver in the approaching lane to interpret the meaning of the traffic light on his own. With the introduction of autonomous vehicles, it is desirable to have the vehicle be able to interpret the meaning of the traffic light without human intervention. Accordingly, it is desirable to provide a system by which a vehicle can interpret a meaning of a traffic light based on a lane that it occupies and move through the intersection based on the meaning.

### SUMMARY

In one exemplary embodiment, a method of operating a vehicle is disclosed. A lane within a road that is occupied by the vehicle and an attribute of the lane are identified. A motion control signal of a traffic control device associated with the road is determined. A semantic meaning is associated to the motion control signal. A maneuver for the vehicle is determined based on the semantic meaning of the motion control signal and the attribute of the lane occupied by the vehicle. The maneuver is performed at the vehicle.

In addition to one or more of the features described herein, the road includes a first lane and a second lane and the method further includes associating a first semantic meaning to the motion control signal when the vehicle is in the first lane and associating a second semantic meaning to the motion control signal when the vehicle is in the second lane. Associating the semantic meaning to the motion control signal further includes associating a plurality of semantic meanings to the motion control signal and determining the maneuver for the vehicle further includes determining the semantic meaning for the lane occupied by the vehicle from the plurality of semantic meanings based on the attribute of the lane occupied by the vehicle. The method further includes associating the semantic meaning to the motion control signal by determining a value of a parameter of a light of the traffic control device, the parameter including at least one of a color of the light, a symbol of the light, and a dynamic state of the light. Associating the semantic meaning to the motion control signal further includes obtaining the semantic meaning from a look-up table using the value of the parameter of the light. The method further includes obtaining a map of the road, the map showing the lane of the road and the attribute of the lane. The method further includes identifying the lane occupied by the vehicle using a sensor of the vehicle.

In another exemplary embodiment, a system for operating a vehicle is disclosed. The system includes a first sensor, a second sensor and a processor. The first sensor captures an image of a traffic control device. The second sensor identifies a lane within a road that is occupied by the vehicle. The processor is configured to determine an attribute of the lane occupied by the vehicle, associate a semantic meaning to a motion control signal of the traffic control device, determine a maneuver for the vehicle based on the semantic meaning of the motion control signal and the attribute of the lane occupied by the vehicle, and perform the maneuver at the vehicle.

In addition to one or more of the features described herein, the road includes a first lane and a second lane and the processor is further configured to associate a first semantic meaning to the motion control signal when the vehicle is in the first lane and associate a second semantic meaning to the motion control signal when the vehicle is in the second lane. The processor is further configured to associate the semantic meaning to the motion control signal by associating a plurality of semantic meanings to the motion control signal and determining the semantic meaning for the lane occupied by the vehicle from the plurality of semantic meanings based on the attribute of the lane occupied by the vehicle. The processor is further configured to associate the semantic meaning to the motion control signal by determining a value of a parameter of a light of the traffic control device, the parameter including at least one of a color of the light, a symbol of the light, and a dynamic state of the light. The processor is further configured to associate the semantic meaning to the motion control signal by obtaining the semantic meaning from a look-up table using the value of the parameter of the light. The processor is further configured to obtain a map of the road, the map showing the lane of the road and the attribute of the lane. In an embodiment, the first sensor is further configured to identify the lane occupied by the vehicle.

In yet another exemplary embodiment, a vehicle is disclosed. The vehicle includes a first sensor, a second sensor and a processor. The first sensor captures an image of a traffic control device. The second sensor identifies a lane within a road that is occupied by the vehicle. The processor is configured to determine an attribute of the lane occupied by the vehicle, associate a semantic meaning to a motion control signal of the traffic control device, determine a maneuver for the vehicle based on the semantic meaning of the motion control signal and the attribute of the lane occupied by the vehicle, and perform the maneuver at the vehicle.

In addition to one or more of the features described herein, the road includes a first lane and a second lane and the processor is further configured to associate a first semantic meaning to the motion control signal when the vehicle is in the first lane and associate a second semantic meaning to the motion control signal when the vehicle is in the second lane. The processor is further configured to associate the semantic meaning to the motion control signal by associating a plurality of semantic meanings to the motion control signal and determining the semantic meaning for the lane occupied by the vehicle from the plurality of semantic meanings based on the attribute of the lane occupied by the vehicle. The processor is further configured to associate the semantic meaning to the motion control signal using a value of a parameter of a light of the traffic control device, the parameter including at least one of a color of the light, a symbol of the light, and a dynamic state of the light. The processor is further configured to associate the semantic meaning to the motion control signal by obtaining the semantic meaning from a look-up table using the value of the parameter of the light. The processor is further configured to obtain a map of the road, the map showing the lane of the road and the attribute of the lane.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle, in an illustrative embodiment;

FIG. 2 shows a map of an intersection that can be obtained from a map server at the vehicle;

FIG. 3 shows an image that can be captured by a camera of the vehicle; and

FIG. 4 shows a flow chart for performing a vehicle maneuver at an intersection based on a motion control signal provided by a traffic control device.

### DETAILED DESCRIPTION

The following description is merely exemplary in nature and is not intended to limit the present disclosure, its application or uses. It should be understood that throughout the drawings, corresponding reference numerals indicate like or corresponding parts and features.

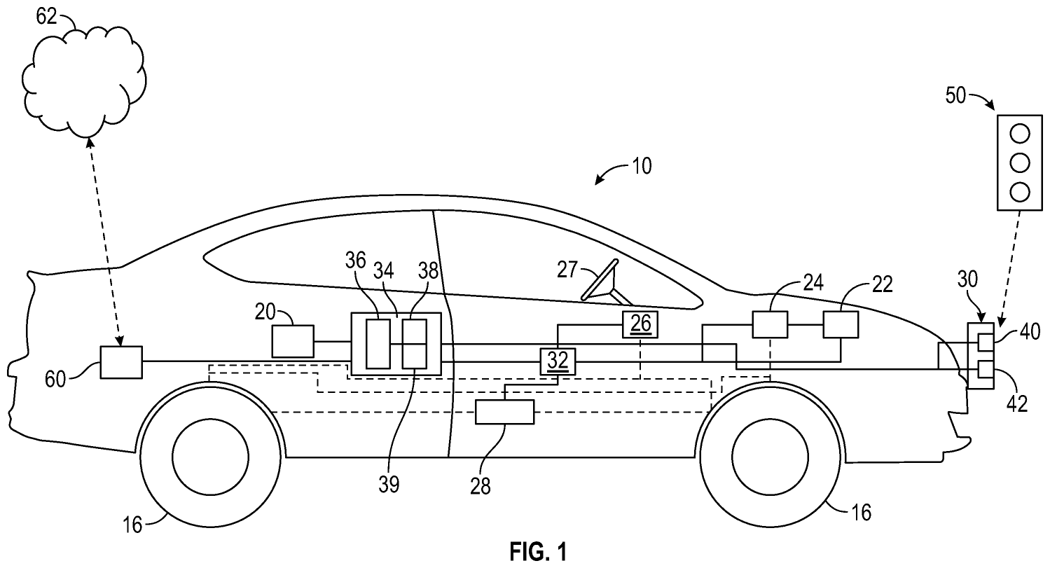

In accordance with an exemplary embodiment, FIG. 1 shows a vehicle 10. In an exemplary embodiment, the vehicle 10 is a so-called Level Four or Level Five automation system. A Level Four system indicates “high automation,” referring to the driving mode-specific performance by an automated driving system of all aspects of the dynamic driving task, even if a human driver does not respond appropriately to a request to intervene. A Level Five system indicates “full automation,” referring to the full-time performance by an automated driving system of all aspects of the dynamic driving task under all roadway and environmental conditions that can be managed by a human driver. It is to be understood that the system and methods disclosed herein can also be used with an autonomous vehicle operating at any of Levels One through Five.

The vehicle 10 generally includes at least a navigation system 20, a propulsion system 22, a transmission system 24, a steering system 26, a brake system 28, a sensor system 30, an actuator system 32, and a controller 34. The navigation system 20 determines a road-level route plan for automated driving of the vehicle 10. The propulsion system 22 provides power for creating a motive force for the vehicle 10 and can, in various embodiments, include an internal combustion engine, an electric machine such as a traction motor, and/or a fuel cell propulsion system. The transmission system 24 is configured to transmit power from the propulsion system 22 to two or more wheels 16 of the vehicle 10 according to selectable speed ratios. The steering system 26 influences a position of the two or more wheels 16. While depicted as including a steering wheel 27 for illustrative purposes, in some embodiments contemplated within the scope of the present disclosure, the steering system 26 may not include a steering wheel 27. The brake system 28 is configured to provide braking torque to the two or more wheels 16.

The vehicle 10 is shown approaching a traffic control device 50 that controls traffic flow. The traffic control device 50 can be a traffic light located at an intersection. The sensor system 30 includes at least a first sensor 40 for obtaining data that provides information on a state of the traffic control device 50. The first sensor 40 can be a camera, such as a digital camera, that obtains or captures an image. In general, the camera is located at a front location of the vehicle and is disposed to have a forward-facing orientation. The camera therefore captures an image of the traffic control device 50 in front of the vehicle 10 and of the road in front of the vehicle. The sensor system 30 can also include a second sensor 42 for determining a location of the vehicle 10 within a road. The second sensor 42 can include at least one of a radar system, a Lidar system, another camera, etc. The second sensor 42 can be used to help determine lane markings of the road and a lane which is being occupied by the vehicle. In various embodiments, the first sensor 40 can also be used to determine lane markings of the road and the lane being occupied.

The vehicle 10 further includes a communication device 60 that communicates, at least in part, with a remote server 62. The remote server 62 can be a map server that provides a map to the vehicle 10 based on the location of the vehicle. In particular, the remote server 62 can provide a map of an intersection being approached by the vehicle 10.

The controller 34 includes a processor 36 and a computer readable storage device or storage medium 38. The storage medium includes programs or instructions 39 that, when executed by the processor 36, operate the vehicle 10 as disclosed herein. In various embodiments, the processor 36 instructs the vehicle to perform a maneuver based on a motion control signal or traffic control signal being broadcast by a traffic control device 50. The processor 36 can determine a semantic meaning of the motion control signal being broadcast by the traffic control device 50. The semantic meaning can be applied to the particular lane being occupied by the vehicle 10 to determine a permission (or lack of permission) for the vehicle, thereby instructing the vehicle with respect to the possible maneuvers available to the vehicle. The controller 34 can then control the actuator system 32, propulsion system 22, transmission system 24, steering system 26, and/or brake system 28 in order to perform a maneuver that navigates the vehicle 10 through the intersection.

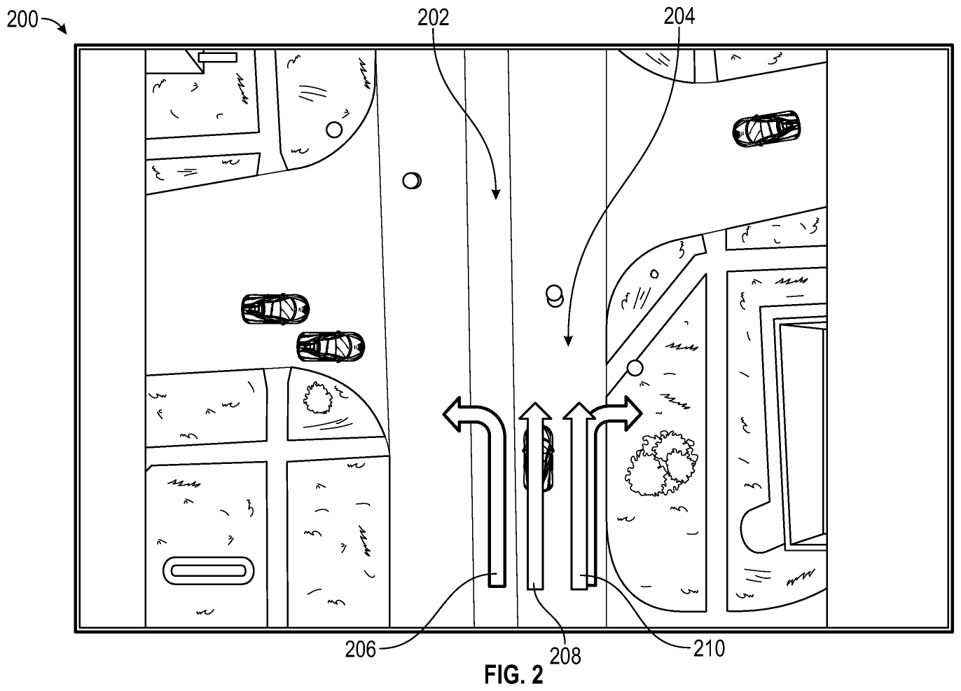

FIG. 2 shows a map 200 of an intersection 202 that can be obtained from the map server at the vehicle 10, in an illustrative embodiment. The map 200 includes an aerial image of the intersection 202 and a road 204 that approaches the intersection and by which the vehicle 10 can approach the intersection 202. The map 200 includes labels for each lane of the road that indicate an attribute of the lane. The attribute of a lane includes or describes the allowed or permitted movements for a vehicle in the lane. For example, the attribute for left lane 206 is “left turn only” and the attribute for middle lane 208 is “through lane.” Right lane 210 allows both a right hand turn and through traffic. Therefore, the attribute for right lane 210 is “shared thru and right turn lane.” A list of attributes includes, but is not limited to, “left turn lane,” “right turn lane,” “thru lane,” shared thru and left turn lane,” “shared thru and right turn lane,” and “U-turn lane.”

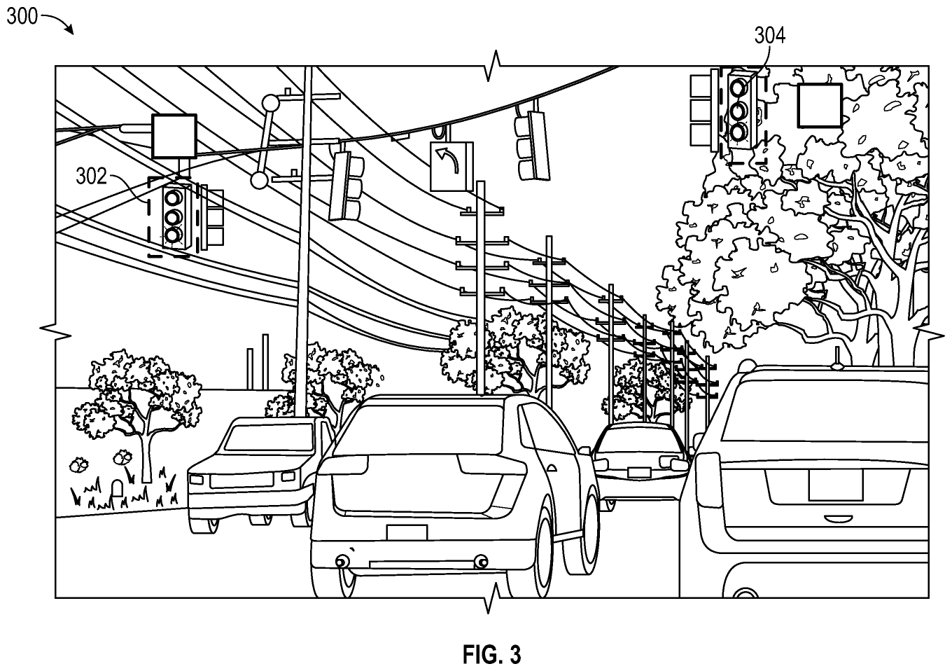

FIG. 3 shows an image 300 that can be captured by the camera of the vehicle 10, in an illustrative embodiment. The image 300 shows a first traffic control device 302 and a second traffic control device 304 that are oriented towards the vehicle 10 to provide a signal to the vehicle. An image processor running at the processor 36 can be used locate the traffic control devices within the image 300 and to determine a motion control signal being broadcasted by each of the first traffic control devices. Each traffic control device includes one or more lights that are turned on and off in order to broadcast a motion control signal that controls traffic. At the vehicle, the processor 36 determines a semantic meaning of the motion control signal using, in part, an understand of the parameters of the light that is used to make the signal. The signal parameters include at least a color of the light (e.g., red, yellow, green), a symbol projected by the light (e.g., right arrow, left arrow, thru arrow, U-turn arrow, ball of light) and a dynamic state of the light (e.g., solid on, flashing, off).

In various embodiments, the signal can be used as input to a look-up table that associates the signal to a semantic meaning and outputs the semantic meaning. An illustrative look-up table is shown below:

| | | Signal | | |
|---|---|---|---|---|
| Semantic Meaning | | Color | Dynamic state | Symbol |
| Protected | RHT | Green | Solid | Right arrow |
| Protected | Thru | Green | Solid | Ball |
| Protected | Thru | Green | Solid | Thru Arrow |
| Protected | LHT | Green | Solid | Left Arrow |
| Permissive | RHT | Green | Solid | Ball |
| Permissive | RHT | Yellow | Flashing | Right Arrow |
| Permissive | RHT | Red | Solid | Ball |
| Permissive | RHT | Red | Flashing | Ball |
| Permissive | RHT | Red | Flashing | Right Arrow |
| Permissive | Thru | Red | Flashing | Ball |
| Permissive | LHT | Green | Solid | Ball |
| Permissive | LHT | Yellow | Flashing | Arrow Left |
| Permissive | LHT | Red | Flashing | Ball |
| Permissive | LHT | Red | Flashing | Arrow Left |
| Forbidden | RHT | Red | Solid | Arrow Right |
| Forbidden | Thru | Red | Solid | Ball |
| Forbidden | Thru | Red | Solid | Arrow Thru |
| Forbidden | LHT | Red | Solid | Arrow Left |
| Forbidden | LHT | Red | Solid | Ball |

where RHT is a right hand turn and LHT is a left hand turn.

The signal parameters are found on the right side of the table and are used to select the semantic meaning found on the left side of the table. For example, the semantic meaning for a Green Solid Ball corresponds to a Protected Thru permission and a Permissive Right Turn, as well as a Permissive Left Turn. Thus, the look-up table can provide a plurality of semantic meanings for a given input or traffic signal. The final meaning of the motion control signal as interpreted at the vehicle depends on the lane the vehicle occupies.

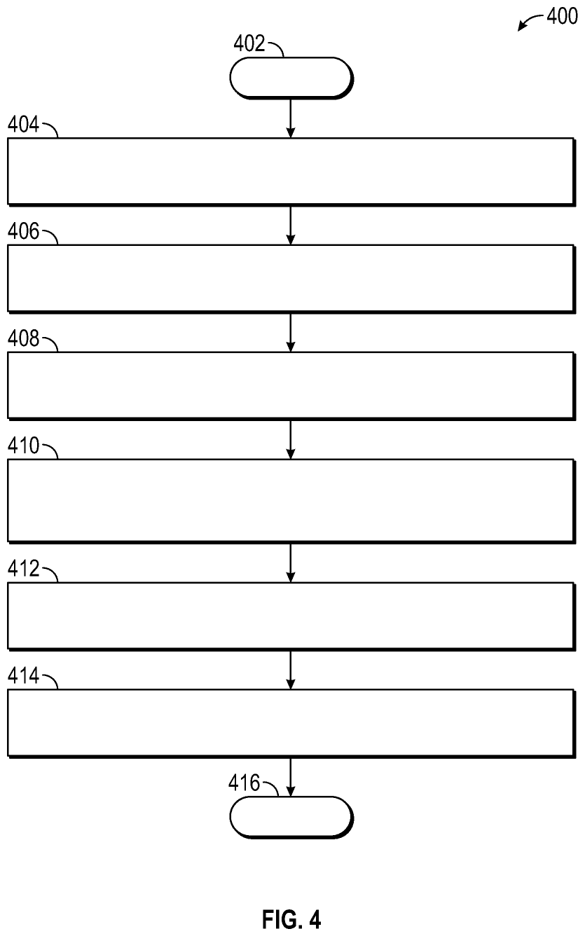

FIG. 4 shows a flow chart 400 for performing a vehicle maneuver at an intersection based on a motion control signal provided by a traffic control device 50. The traffic control device 50 is located at an intersection having a road with one or more approaching lanes. Each lane has an associated attribute that controls the flow of traffic in the lane. As the vehicle 10 approaches the intersection, it can select or identify a lane by which the vehicle can complete an intended route or journey. For example, the vehicle 10 can choose its lane based on whether it intends to make a left turn, make a right turn, or proceed straight through the intersection.

The method starts in box 402 as the vehicle 10 approaches the intersection. For each lane, the initial semantic meaning of the light is set at “red=stop” by default. In box 404, the attributes for each of the lanes of the road are determined. In various embodiments, a map is received at the vehicle that shows the lanes and their respective attributes. In box 406. a motion control signal being broadcast by a traffic control device is observed, captured or sensed. In box 408, the motion control signal from the traffic control device is used as input to a look-up table to determine a permission for the vehicle. In particular, the parameters of the light of the traffic control device transmitting the motion control signal are used at the look-up table to select the semantic meaning of the motion control signal.

In box 410, the semantic meaning is matched with or applied to the approaching lanes to the intersection based on the attributes of the lanes. In general, a vehicle in a first lane can associate a first semantic meaning to the signal, while a vehicle in a second lane can associate a second semantic meaning to the signal. For example, considered the signal of a Green Solid Ball at the traffic control device, which can have the semantic meaning of Protected Thru, Permissive Right Turn, and Permissive Left Turn. In the map 200 of FIG. 2, left lane 206 has the attribute of being a “left turn only” lane and therefore the semantic meaning of “Permissive Left Turn” applies to it. Similarly, since middle lane 208 has the attribute of being a “through lane”, the semantic meaning of “Protected Thru” applies. Also, since right lane 210 has the attribute that it is “shared thru and right-hand turn lane,” the semantic meaning of Protected Thru and Permissive Right Turn applies.

In box 412, a maneuver is selected that complies with the semantic meaning of the motion control signal that corresponds to the lane occupied by the vehicle. For example, if the vehicle 10 is in left lane 206, the semantic meaning that is selected by the vehicle is “Permissive Left Turn”. This semantic meaning instructs the vehicle 10 to check for the safety of a left turn before attempting the maneuver. In box 414, the vehicle 10 performs the selected maneuver. In box 416, the method ends as the vehicle 10 exits the intersection and drives away.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of operating a vehicle, comprising:
identifying a lane within a road that is occupied by the vehicle and an attribute of the lane;
determining a motion control signal of a traffic control device associated with the road;
associating a semantic meaning to the motion control signal;
determining a maneuver for the vehicle based on the semantic meaning of the motion control signal and the attribute of the lane occupied by the vehicle; and
performing the maneuver at the vehicle.

2. The method of claim 1, wherein the road includes a first lane and a second lane, further comprising associating a first semantic meaning to the motion control signal when the vehicle is in the first lane and associating a second semantic meaning to the motion control signal when the vehicle is in the second lane.

3. The method of claim 1, wherein associating the semantic meaning to the motion control signal further comprises associating a plurality of semantic meanings to the motion control signal and determining the maneuver for the vehicle further comprises determining the semantic meaning for the lane occupied by the vehicle from the plurality of semantic meanings based on the attribute of the lane occupied by the vehicle.

4. The method of claim 1, further comprising associating the semantic meaning to the motion control signal by determining a value of a parameter of a light of the traffic control device, the parameter including at least one of: (i) a color of the light; (ii) a symbol of the light; and (iii) a dynamic state of the light.

5. The method of claim 4, wherein associating the semantic meaning to the motion control signal further comprises obtaining the semantic meaning from a look-up table using the value of the parameter of the light.

6. The method of claim 1, further comprising obtaining a map of the road, the map showing the lane of the road and the attribute of the lane.

7. The method of claim 1, further comprising identifying the lane occupied by the vehicle using a sensor of the vehicle.

8. A system for operating a vehicle, comprising:
a first sensor for capturing an image of a traffic control device;
a second sensor for identifying a lane within a road that is occupied by the vehicle; and
a processor configured to:
determine an attribute of the lane occupied by the vehicle;
associate a semantic meaning to a motion control signal of the traffic control device;
determine a maneuver for the vehicle based on the semantic meaning of the motion control signal and the attribute of the lane occupied by the vehicle; and
perform the maneuver at the vehicle.

9. The system of claim 8, wherein the road includes a first lane and a second lane, the processor further configured to associate a first semantic meaning to the motion control signal when the vehicle is in the first lane and associate a second semantic meaning to the motion control signal when the vehicle is in the second lane.

10. The system of claim 8, wherein the processor is further configured to associate the semantic meaning to the motion control signal by associating a plurality of semantic meanings to the motion control signal and determining the semantic meaning for the lane occupied by the vehicle from the plurality of semantic meanings based on the attribute of the lane occupied by the vehicle.

11. The system of claim 8, wherein the processor is further configured to associate the semantic meaning to the motion control signal by determining a value of a parameter of a light of the traffic control device, the parameter including at least one of: (i) a color of the light; (ii) a symbol of the light; and (iii) a dynamic state of the light.

12. The system of claim 11, wherein the processor is further configured to associate the semantic meaning to the motion control signal by obtaining the semantic meaning from a look-up table using the value of the parameter of the light.

13. The system of claim 8, wherein the processor is further configured to obtain a map of the road, the map showing the lane of the road and the attribute of the lane.

14. The system of claim 8, wherein the first sensor is further configured to identify the lane occupied by the vehicle.

15. A vehicle, comprising:
a first sensor for capturing an image of a traffic control device;
a second sensor for identifying a lane within a road that is occupied by the vehicle; and
a processor configured to:
determine an attribute of the lane occupied by the vehicle;
associate a semantic meaning to a motion control signal of the traffic control device;
determine a maneuver for the vehicle based on the semantic meaning of the motion control signal and the attribute of the lane occupied by the vehicle; and
perform the maneuver at the vehicle.

16. The vehicle of claim 15, wherein the road includes a first lane and a second lane, the processor further configured to associate a first semantic meaning to the motion control signal when the vehicle is in the first lane and associate a second semantic meaning to the motion control signal when the vehicle is in the second lane.

17. The vehicle of claim 15, wherein the processor is further configured to associate the semantic meaning to the motion control signal by associating a plurality of semantic meanings to the motion control signal and determining the semantic meaning for the lane occupied by the vehicle from the plurality of semantic meanings based on the attribute of the lane occupied by the vehicle.

18. The vehicle of claim 15, wherein the processor is further configured to associate the semantic meaning to the motion control signal using a value of a parameter of a light of the traffic control device, the parameter including at least one of: (i) a color of the light; (ii) a symbol of the light; and (iii) a dynamic state of the light.

19. The vehicle of claim 18, wherein the processor is further configured to associate the semantic meaning to the motion control signal by obtaining the semantic meaning from a look-up table using the value of the parameter of the light.

20. The vehicle of claim 15, wherein the processor is further configured to obtain a map of the road, the map showing the lane of the road and the attribute of the lane.
